(19) United States
(12) Patent Application Publication
(10) Pub. No.: US 2013/0040082 A1
(43) Pub. Date: Feb. 14, 2013

(54) COMPOUNDS AND COMPOSITIONS FOR SUSCEPTOR MATERIALS

(71) Applicants: Francesco Mascia, Guanzate (CO) (IT); Francesco Fratton, Ronago (IT)

(72) Inventors: Francesco Mascia, Guanzate (CO) (IT); Francesco Fratton, Ronago (IT)

(73) Assignee: MICROENERGY S.R.L., Lomazzo (CO) (IT)

(21) Appl. No.: 13/576,462

(22) PCT Filed: Feb. 7, 2011
(86) PCT No.: PCT/IB11/00202

§ 371 Date: Oct. 9, 2012

(30) Foreign Application Priority Data
Feb. 5, 2010 (IT) MI2010A000180

(51) Int. Cl. C09K 5/00; B65D 81/34; C01B 33/20

(52) U.S. Cl. 428/34.1; 423/326; 252/71; 252/74

(57) ABSTRACT

Inorganic compositions include at least one inorganic compound of iron silicate as it is, or mixed with at least one binding compound able to increase the temperature of the composition when the composition is exposed to irradiation caused by an electromagnetic field or electromagnetic waves and are therefore usable for the production of susceptor materials.

### FIELD OF THE INVENTION

The present invention generally relates to compounds and compositions for susceptor materials. A susceptor is a material or compound used for its ability to absorb electromagnetic energy and convert it to heat, which is sometimes designed to be re-emitted as infrared thermal radiation. More specifically, the invention relates to compositions capable of increasing in temperature when exposed to radiation caused by an electromagnetic field or by electromagnetic waves. The present invention further relates to manufactured composite articles made with such compositions, and their use for the heating of a material.

### BACKGROUND OF THE INVENTION

The use of radiation from an electromagnetic field or electromagnetic waves, such as for example radio frequency and microwave radiation, as a source of energy for heating and cooking has long been known and is based on the fact that electromagnetic radiation excites the molecular motion of certain compounds, including water, causing the heating thereof. These compounds, referred to below, for the purposes of the present invention, as “susceptor compounds”, are able to absorb high frequency electromagnetic energy and convert it into heat and/or radiation in the infrared range. For example, known compounds for this purpose are silicon carbide, carbon (usually in the form of graphite or carbon black) metals such as aluminum, copper, zinc, iron, tin and nickel, preferably in the form of metal oxides, in particular FeO, magnetite and Fe₂O₃.

The use of materials referred to below for the purposes of the present invention as “susceptor materials”, which incorporate the above mentioned susceptor compounds is also known. Thanks to the presence of susceptor compounds these materials increase their temperature when exposed to high-frequency radiation, such as that of microwaves; thus lending themselves to different applications, such as cooking food, in particular the cooking of their surface. According to the use of the susceptor material and the temperature to be reached, the susceptor compounds are dispersed in or bound to different organic or inorganic binders.

For the surface cooking of foods (so-called “browning” or “crisping”), typical susceptors are provided in the form of sheets and polyester films (PET) metallized with aluminum deposited in thin layers. These sheets are normally used in food packaging, i.e. coupled with cardboard or paper, and are placed in contact with food to give it the coloring and cooking needed. The susceptors of this type are not capable of withstanding repeated cycles of heating, and the packaging is thrown away after use. An additional problem is that the film in PET can release oligomers in cooked food, as reported in Begley et al., Migration into food of polyethylene terephthalate (PET) cyclic oligomers from PET microwave susceptor packaging Food Addit Contam. 1990 November-December; 7(6):797-803.

In order to address the problems mentioned above the so-called cooking “dishes” (crisping dish), in which the active susceptor compound, which reacts to microwaves, is dispersed in an inorganic binder and is applied to the upper layer of a support in dish shape, which is also generally inorganic are also known. A problem with these dishes is the fact that the susceptor compounds are not normally suitable for food contact. To resolve this problem, over the layer of susceptor material (e.g. graphite and sodium silicate) a layer of inert polymer material is applied such as Teflon®, making the surface of the dish suitable for food contact.

Susceptor materials are also used in industrial heating, in applications varying greatly one from the other, for example, susceptors having silicon carbide as an active compound are known for the production of crucibles for the sintering of dental prosthesis in zirconium; more generally, different types of industrial or domestic heating appliances can be made with susceptor materials.

### DISCUSSION OF THE PRIOR ART

U.S. Pat. No. 4,956,533 relates to ceramic compositions usable in disposable packaging for precooked foods to be heated in microwave ovens. According to this patent alumina (Al₂O₃), sodium metasilicate, kaolin, talc or similar ceramic materials are used in the hydrated form, alone or in combination with each other. Such materials are used along with a variety of binders ranging from PVC to gypsum, which are mixed in a wet state, and then dried to have a water content in the range between 2.5% and 10%. The disadvantages of this embodiment are due to the fact that heating is essentially based on the presence of water in the mixture of absorber compounds and the fact that the materials are not able to withstand prolonged or repeated cycles of heating.

U.S. Pat. No. 5,183,787 relates to a ceramic composition usable as a susceptor for microwave heating. The ceramic composites are selected from vermiculite, bentonite, hectorite and zeolites, both in their original and amphoteric form. The compounds are previously activated by treatment with acids or bases in order to chemically modify the ceramic structure and add —OH groups. The activated materials are then mixed with a binder according to standard treatment technology of raw ceramics. The disadvantages of this solution are due to the fact that heating is mainly based on the presence of water in the mixture and the fact that the materials are not able to withstand repeated or prolonged heating cycles.

EP 0496130 A2 discloses a susceptor composition constituted by a mixture of an inert binder, i.e. transparent to microwave and radio frequencies, such as sodium silicate, with a susceptor compound reactive to microwaves, such as carbon. The main disadvantage of this composition is given by the difficulty of controlling the heating: as a result of repeated heating by microwaves, the temperature of the composition continues to increase, thus causing considerable problems of temperature control and considerable difficulties in resisting prolonged or repeated heating cycles.

WO 97/24295 discloses a crisping dish that has a sodium silicate foam backing layer (or another alkaline earth silicate), anhydrous, i.e. a material transparent to microwaves (see page 5, lines 4-5), which has a non-foam smooth side on which is laid a layer of anhydrous silicate in which susceptor materials are incorporated, in particular graphite; above the active layer, containing susceptors, is applied a layer of high temperature—resistant polymer, in particular Teflon®, which allows contact with food. In general, therefore, the known susceptor materials are isolated from contact with the food since unfit to that purpose; they are also isolated from contact with the atmosphere to avoid oxidation. In particular, FeO oxidizes to Fe₂O₃, which is a composite susceptor much less active than FeO.

### SUMMARY OF THE INVENTION

The present invention addresses the problems of the known prior art providing susceptor compounds and compositions containing the same and suitable for being used as susceptor materials, i.e. materials capable of absorbing energy from an electromagnetic field, or anyway electromagnetic waves, converting it into heat.

The present invention provides susceptor compounds and compositions of the type mentioned above which can be easily found on the market at limited costs. The present invention provides compositions of the above mentioned type which may be used for the realization of manufactured composites of shapes suitable for several applications.

The present invention presents a simple and inexpensive process for creating manufactured composites of various shapes utilizing the compositions of the type mentioned above.

The present invention also concerns a manufactured article containing iron silicate.

The present invention also concerns using a synthetic granulated slag resulting from the refining of ferrous and non ferrous metals, in particular as a byproduct of copper metallurgy for the production of compositions and manufactured articles.

The present invention also concerns the use of a composition according to the present invention to produce heating elements of various kinds and various shapes, such as, for example, heat exchangers or coatings thereof, containers for heating or cooking foods such as pots, pans and bowls, plates for cooking food and/or heating of the cooking units, tiles and hot-plates for ovens, heating elements of cylindrical shape similar to resistors, heating elements installed in boilers to produce sanitary hot water and/or heating, fan coil units for heating air and the like.

A composite manufactured article in accordance with the present invention can be used in various ways, for example by subjecting it to electromagnetic radiation in the microwave range, radio frequency and/or infrared range.

### BRIEF DESCRIPTION OF THE DRAWINGS

FIG. 1 is a schematic representation of the behavior of various types of materials subjected to radiation from an electromagnetic field or from electromagnetic waves.

FIG. 2 is a graph reporting the measurements of the loss tangent of a granular composition sample according to the present invention as a function of the pressure applied to the granules and the comparison of the values of the material known to have a high absorption of electromagnetic radiation.

FIG. 3 is a schematic representation in perspective of a microwave instrument used to execute heating tests.

FIGS. 3A and 3B respectively represent the configuration of the electric field and the magnetic field generated inside the instrument of FIG. 3 according to a longitudinal section.

FIGS. 4 and 5 are representations of temperature and reflected power curves measured for the composition sample of the present invention as a function of time respectively applying two different power levels of the instrument of FIG. 3.

FIG. 6 is a representation of the temperature and reflected power curves detected as a function of time for certain preliminary examples obtained with compositions according to the present invention and subjected to repeated cycles of radiation and deactivation of the instrument of FIG. 3.

FIG. 7 is a representation of the temperature curve and power curve absorbed by the system detected as a function of time for a first sample obtained with compositions according to the present invention and subjected to repeated cycles of radiation and deactivation of the instrument of FIG. 3.

FIG. 8 is a representation similar to the one of FIG. 7 for a second composition sample.

FIG. 9 is a representation similar to the one of FIG. 7 for a third composition sample.

### DETAILED DESCRIPTION OF THE INVENTION

The present invention relates to a composition that is able to increase its temperature when exposed to radiation caused by an electromagnetic field or electromagnetic waves, in which the composition includes iron silicate as a susceptor compound, i.e. as a compound that is susceptible to microwaves and radio frequencies, and that heats up when exposed to them. Preferably, the composition is substantially anhydrous and iron silicate is in the form of particles dispersed in an organic or inorganic binder. In one aspect of the invention, the inorganic binder is selected from clays and similar materials suitable for the production of ceramics, tiles and slabs in general.

The present invention relates to a new use of the known compound iron silicate. It was in fact surprisingly found that the compound iron silicate —Fe₂SiO₄— (where iron has valence 2) when subjected to radiation from an electromagnetic field or electromagnetic waves (e.g. microwaves), generates a large amount of heat and can then be used as an active compound, by itself or in a susceptor material. The iron silicate and a susceptor material containing Fe₂SiO₄ and an inorganic binder are able to reach very high temperatures.

For the purposes of the present invention, the term “iron silicate” refers to the compound Fe₂SiO₄ in its various degrees of purity and said term particularly includes the inorganic compound of iron silicate that is known as a synthetic granulated slag resulting from the refining of ferrous and non ferrous metals, in particular as a byproduct of copper metallurgy. Obtained by cooling the molten slag in water, the “iron silicate” is a solid of a shiny and glassy black color. The aforesaid slag is normally referred to as “iron silicate” and is used as such, without any special preventive refining.

Inorganic compounds selected according to the invention are readily available on the market at a very low cost, since they are production scraps generally destined for other uses. It preferably concerns in fact slag from the refining of copper, zinc, nickel and other nonferrous metals that undergo similar processes of refining to separate these non-ferrous metals from unwanted components, such as iron for example.

The slag is produced by these metallurgical refining processes and is generally used as abrasives: they are in fact iron silicates in the form of granules which can be used as grit for cleaning surfaces by sanding. In different industries the slag can be identified with different names, such as abrasive powder, sand, grit, copper slag grit, mineral grit, grinding grain, etc.; in any case, inexpensive materials and available worldwide in large quantities.

Other iron silicates are however usable which are readily available on the market, such as mineral grains chosen from fayalite, ferrosilite, olivine and/or kirchsteinite, these products are excluded, in themselves, from the protected scope of the present invention which is instead extended to their use as discussed below. The iron silicate is typically mixed with at least one binder compound, for example a compound selected from a clay base compound, a combustible polymer and a low melting compound, or mixtures thereof.

According to the present invention, at least one inorganic compound susceptible to electromagnetic radiation includes iron silicates. An organic or inorganic binder compound can be mixed to the inorganic compound susceptible to electromagnetic radiation before step b) of the process. For example, the binder compound can be a clay base compound and/or a low melting compound, such as bentonite or similar vitreous materials. In a further embodiment, a polymer or a combustible substance is used as a binder that is eliminated by combustion-oxidation during the sintering procedure of the final manufactured article. An example of this substance is polyvinyl alcohol that is typically used in a diluted aqueous solution.

The present disclosure refers in particular to the radiation from materials by electromagnetic radiation in the microwave range (from 300 MHz to 300 GHz), but it has been found that the same considerations are valid for electromagnetic radiation in frequency ranges typical of dielectric heating (radiofrequencies from about 150 MHz to 300 MHz), and also for higher frequencies, for example radiation in the range of submillimeter waves (300 GHz to 10 THz) and, in particular, in the infrared range.

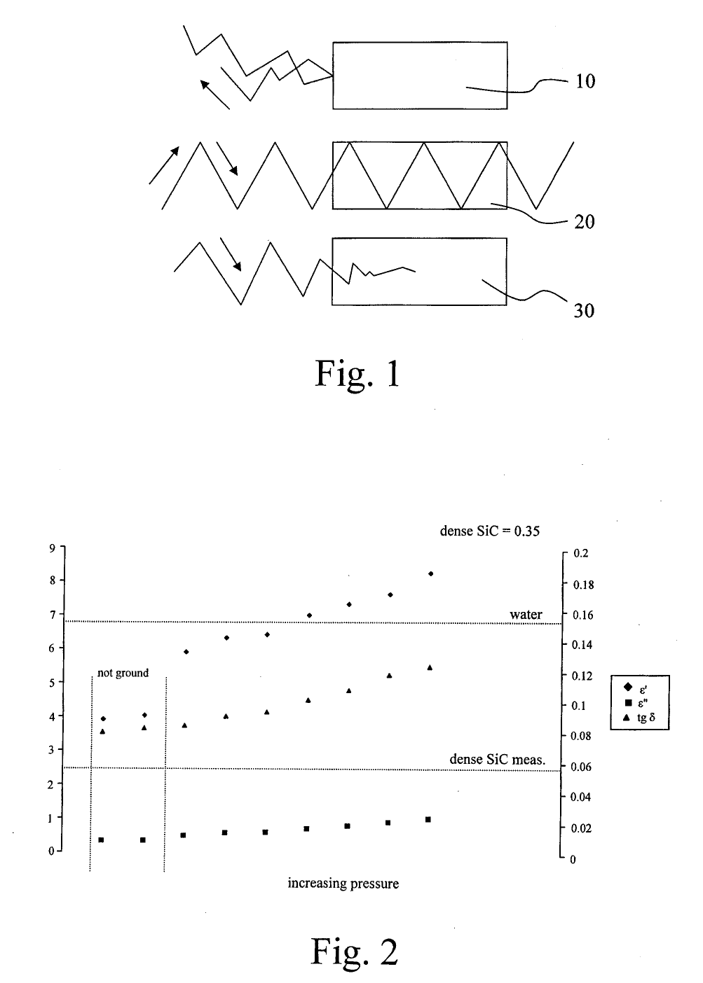

FIG. 1 represents the behavior of different materials, depending on their nature, when subjected to irradiation by radiation from an electromagnetic field or by electromagnetic waves. For example, a conductive material 10 completely reflects the radiation while an insulating material 20 results “transparent” to radiation: in both cases, energy is not absorbed by these materials. There are instead materials 30 that also present high dielectric losses, and are therefore able to absorb at least part of the energy received in the form of electromagnetic radiation and therefore capable of heating up by transforming the absorbed energy into heat. Typical high dielectric loss materials are polar liquids, such as water for example and polar organic materials. Metals instead have a too high conductivity and so they simply reflect the microwave energy without heating up.

Many ceramic materials, such as MgO and SiO₂ behave like dielectrics at room temperature, i.e. “transparent” to electromagnetic radiation in microwave frequencies, but when carried beyond a critical temperature, they begin to absorb it. Other ceramic materials, such as for example Co₂O₃, MnO₂, NiO, SiC e CuO, absorb the microwaves even at room temperature. Electromagnetic radiation, therefore, depending on the type and condition of the material may be transmitted, reflected or absorbed. For example, when a material is irradiated by microwaves, it is under the action of an oscillating magnetic field and an oscillating electric field: from a microscopic point of view, due to the oscillating electric field, there may be polarization phenomena of the material.

From a macroscopic point of view the state of material polarization is described by an electronic polarization factor ∈, or dielectric permittivity, which depends on the type of polarization and the material.

To describe the polarization state of the material in this case there should be a complex polarization factor ∈* that depends on the frequency f of the external electric field. The mechanism of interaction or absorption of microwaves by a dielectric material is therefore linked to its permittivity which is a complex number of the form:

∈*=∈′−j∈″=∈₀(∈′ᵣ−j∈″_{eff})

where:

j=(−1)^{1/2}

∈₀=8.86×10⁻¹² F/m, permittivity in free space;

∈′ᵣ=relative dielectric constant;

∈″_{eff}=factor of effective relative dielectric loss.

For convenience, the loss mechanisms are often combined into a single loss factor tan δ expressed by the relation:

tan δ=∈″_{eff}/∈′ᵣ=σ/2πf∈∈′_{f}

where σ is the total effective conductivity and f is the frequency. The value of ∈′ᵣ is a measure of the polarizability of the material in an electric field, while the value of tan δ is a measure of the loss or absorption of microwave energy within the material.

Additional features of the present invention will become more apparent by the following experimental examples conducted upon a sample composition according to the present invention.

### Example 1

### Analysis of a Sample

A sample was analyzed of a composition according to the present invention in the form of coarse powders deriving from reactions of steel with casting refractories. The physical properties are reported in the following Table 1.

TABLE 1

| property | analysis |
|---|---|
| Hardness (Mohs | 7 |
| Scale) | |
| Density/specific | 3.83 g/cm³ |
| weight | |
| Electrical conductivity | 4.8 mS/m |
| Chloride content | <0.0002 |
| Form of granules | Multi faceted, sharp and angular |
| | edges |
| Granulometry | from 0.2 mm to 3.0 mm |

The diffractometric powder analysis revealed the presence of a high percentage of iron silicates, consisting mainly of fayalite (FeSiO₄), mixed with other silicates such as olivine ((MgFe)₂SiO₄) and kirchsteinite (CaFeSiO₄). The chemical composition of the collected sample in the form of single components or their oxides is reported in the following Table 2.

TABLE 2

| compound | content (weight %) |
|---|---|
| Iron oxide (Fe₂O₃) | 55.00 |
| Silica (SiO₂) | 35.00 |
| Aluminum Oxide (Al₂O₃) | 3.01 |
| Calcium oxide (CaO) | 0.20 |
| Magnesium oxide (MgO) | 0.90 |
| Copper (Cu) | 0.42 |
| Titanium dioxide | 0.60 |
| Potassium oxide | 1.02 |

### Example 2

### Sample Preparation

The sample was in the form of powders with irregular morphology. It was then conducted a further comminution and an application of pressure during measurement to minimize the content of air and ensure good contact with the sensor used to detect the indicative dielectric properties at room temperature.

### Example 3

### Measurement of Dielectric Properties

The sample previously prepared has been subjected to measurement by the technique of the truncated coaxial cable connected to a vector network analyzer; the limitation of this technique is in the need to assure a perfect contact between material and sensor (absence of air in the interface), in the sensitivity of the instrument to variations along the transmission line from the network analyzer to the sensor, as well as the need to ensure a minimum material thickness for measurements, preferably having a loss tangent (ratio between imaginary part and real part of permittivity) greater than 0.01.

The graph represented in FIG. 2 summarizes the values of perceptiveness measured at a frequency of 2.45 GHz, typical of Industrial, Scientific and Medical (ISM) applications of microwaves. On the graph, merely indicative, dielectric properties (values of loss tangent) are reported at 2.45 GHz of materials known to be good absorbers of microwaves, such as water and silicon carbide (SiC).

In general, the absorption of microwaves at 2.45 GHz increases with increasing applied pressure due to decreased volume fraction of air and is favored by comminution. As can be seen, the loss tangent (tan δ) measured for the powders of the sample ground and slightly pressed is higher than that measured for dense silicon carbide, and close to the one of water.

### Example 4

### Preliminary Heating Tests

Preliminary heating tests were carried out by heating certain fractions of the sample previously prepared according to Example 2 and subjecting them to microwave radiation in a single mode applicator.

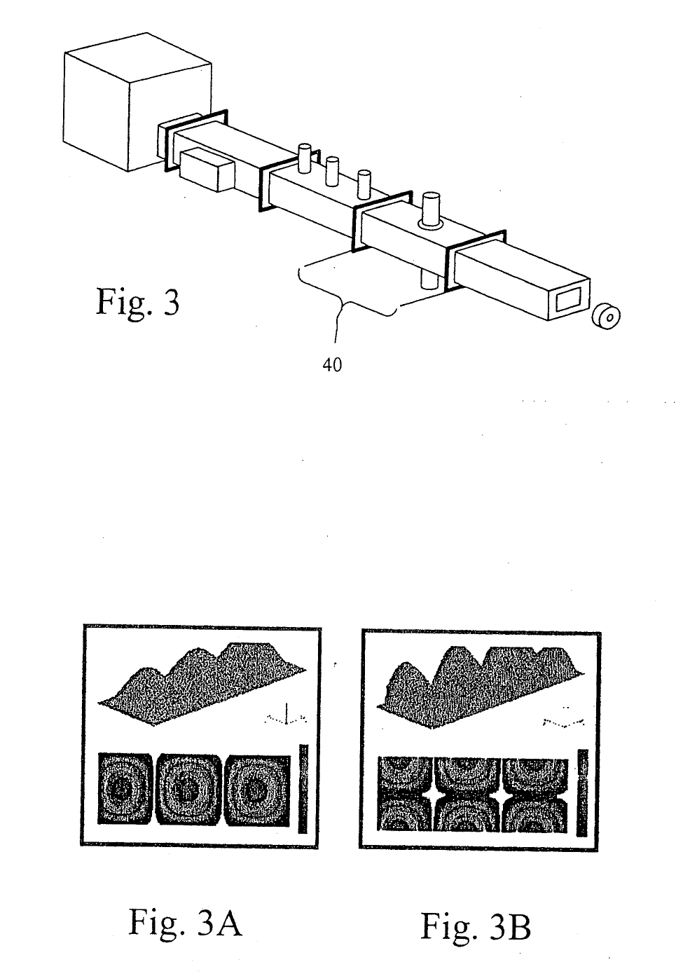

FIG. 3 shows schematically the equipment used, which is equipped with a microwave generator at 2.45 GHz with a maximum power of 3 kW. FIGS. 3A and 3B respectively represent the distribution of the electric field and of the magnetic field in the longitudinal section 40 indicated in FIG. 3. The sample fractions were placed in the area of maximum electric field and the temperature reached was measured by an optical pyrometer.

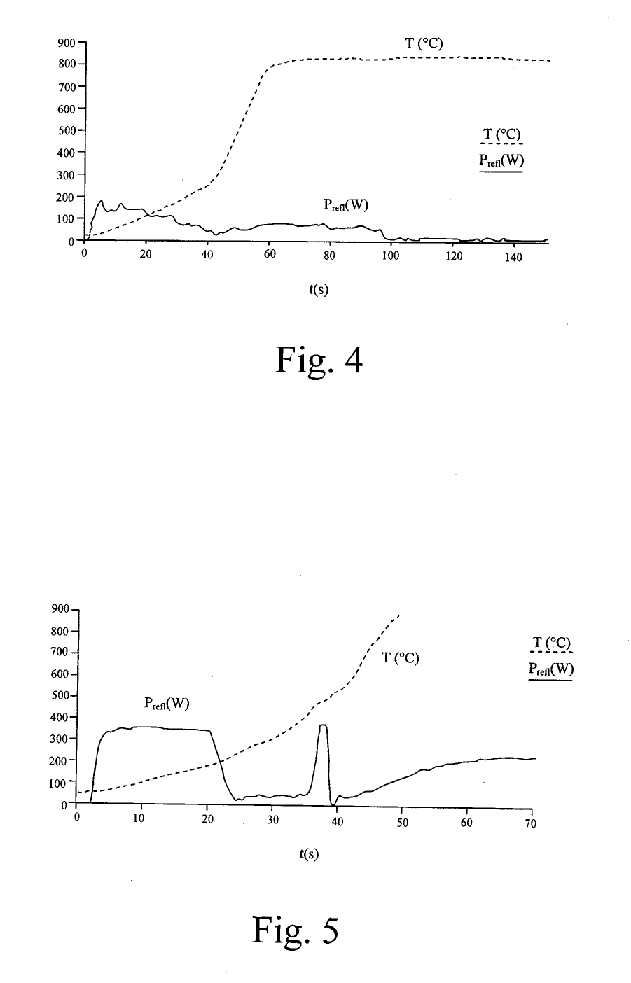

FIG. 4 presents the temperature curve and the reflected power curve as a function of time maintaining the generator at a power of about 630 W. FIG. 5 reports the same temperature and reflected power curves resulting from the application of microwave at the power of about 1260 W.

In the graphs of FIGS. 4 and 5, the reflected power curve, i.e. the power not absorbed by the sample material, was measured by means of directional coupler. The difference between the output power and the reflected one gives approximately the reflected power value absorbed by the system as a whole, i.e. the whole comprising the sample material, the oven, the refractory structure and heat losses.

By examining the temperature curves in both diagrams of FIGS. 4 and 5 one can see that, at the same power delivered to the load, the heating rate of the material tends to increase, probably for the most dissipative behavior of the material (increase of the loss tangent), as the temperature increases.

The curve of reflected power in the diagram of FIG. 4 has a substantially decreasing trend over time, while the reflected power curve in the diagram of FIG. 5 presents a sharp drop corresponding at the discharge phenomena such as electric arcs and plasma formations.

### Example 5

### Preliminary Tests of the Preparation of Sintered and Fused Manufactured Articles

On an experimental basis, specimens of sintered and fused cylindrical manufactured articles were made from grit and powders of the initial sample and from ground and pressed powders according to the preparation of Example 2.

The sintering preliminary tests were conducted at temperatures of 1100° C. and 1300° C. To promote sintering, comminution was carried out on dry and wet ground powders. The forming of cylindrical manufactured articles was then performed by pressing, either by adding an organic binder (PVA, PEG-5 wt % of solution 5 wt %), or and by a clay additive (2 wt % of bentonite).

### Example 6

### Preliminary Tests of Sintering and Heating

Some sintered specimens were exposed to microwaves in the area of maximum electric field of the instrument of FIG. 3, acquiring the temperature and reflected power curves as a function of time. Preliminarily, it has been started from powder samples, sintered by microwave during the first heating cycle, followed by additional cycles of microwave heating and cooling without extracting them from the oven.

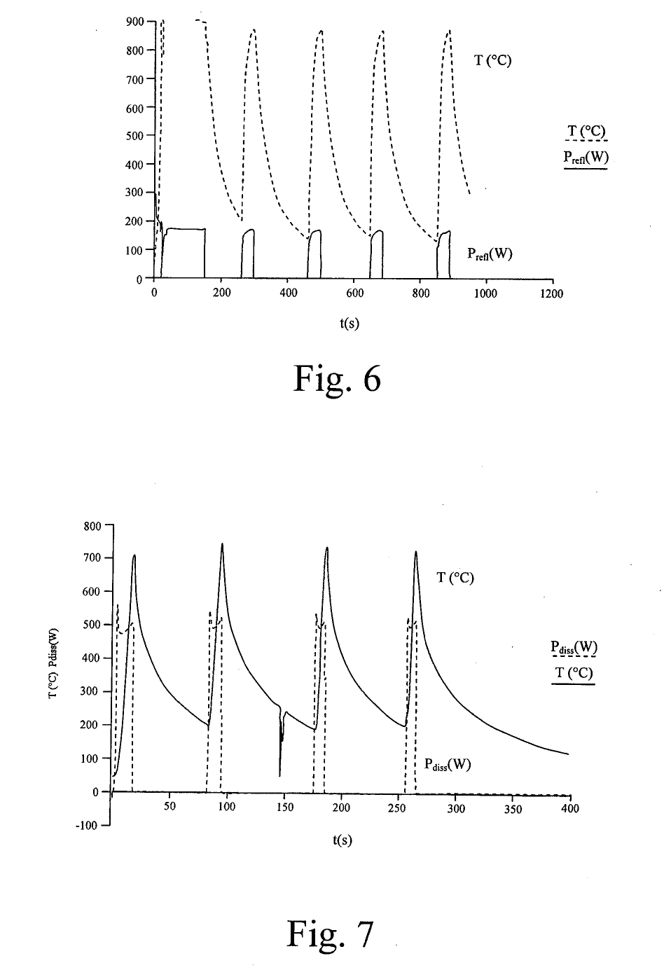

The diagram of FIG. 6 reveals that the powders have, at the same power applied, a higher heating rate during the first cycle; in other words, the temperature curve presents a higher slope in the first cycle, with reflected power that tends towards zero, and then tend to stabilize at a constant value during sintering. In the subsequent cycles heating takes place at a slightly lower speed and consecutive heating tests show no change of the sample behavior to sintering.

### Example 7

### Preparation of Oven Sintered Specimens

Powders and granules of the original sample were wet-milled in a milling jar at high speed (100 g water, 100 g solid, 200 g balls with a diameter in the range of 5 mm-20 mm) for 20 minutes. The resulting powder was then dried in a stove and sieved using 25 micron, 63 micron, 75 micron and 120 micron sieves. The powders obtained are within these size ranges: powders with a granulometry below 25 microns; powders with a granulometry between 25 and 63 microns; powders with a granulometry between 63 and 75 microns; powders with a granulometry between 75 and 120 microns; and powders with a granulometry greater than 120 microns.

Three specimens were then prepared, respectively referred to as A, B and C, consisting of different granulometries, namely:
SPECIMEN A: 40 g of powder with a granulometry less than 25 micron 2 g of bentonite+2 g of water;
SPECIMEN B: 40 g of powder with a granulometry between 25 and 63 micron+2 g of bentonite+2 g of water;
SPECIMEN C: 10 g of powder with a granulometry less than 25 microns+10 g of powder with a granulometry between 25 and 63 microns+10 g of powder with granulometry between 63 and 75 microns+10 g of powder with granulometry between 75 and 120 microns+2 g of bentonite+2 g of water.

The ingredients of each specimen were properly dry mixed and successively pressed at 400 kg/cm² to obtain cylindrical specimens with a diameter of 40 mm and a height between about 5 and 7 mm. The firing took place in a pit furnace with a hollow space (non-oxidizing atmosphere) in static air at 1100° C. for 30 minutes. At the end of the isotherm, each specimen was removed from the oven and air-cooled.

### Example 8

### Heating Tests of the Specimens

To assess the existence of possible differences in behavior between the three specimens sintered in the oven, tests were carried out using the heating instrument of FIG. 3 by placing the specimens in the area of maximum electric field. The heating of each specimen was made following a thermal cycle, repeated four times, between 200 and 700° C. in heating and cooling.

### Specimen A:

Specimen A had a mass of about 2.67 g. The graph in FIG. 7 represents the temperature curve and the curve of power absorbed by the system during the four cycles of radiation and deactivation of the instrument of FIG. 3. The values detected for the temperature and the power absorbed by the system at each cycle are shown in Table 3 below.

TABLE 3
(specimen A)

| cycle | Q (J) | ΔT (° C.) |
|---|---|---|
| 1 | 7331,275 | 654 |
| 2 | 5529,048 | 540 |
| 3 | 4521,800 | 535 |
| 4 | 4021,555 | 521 |

### Specimen B:

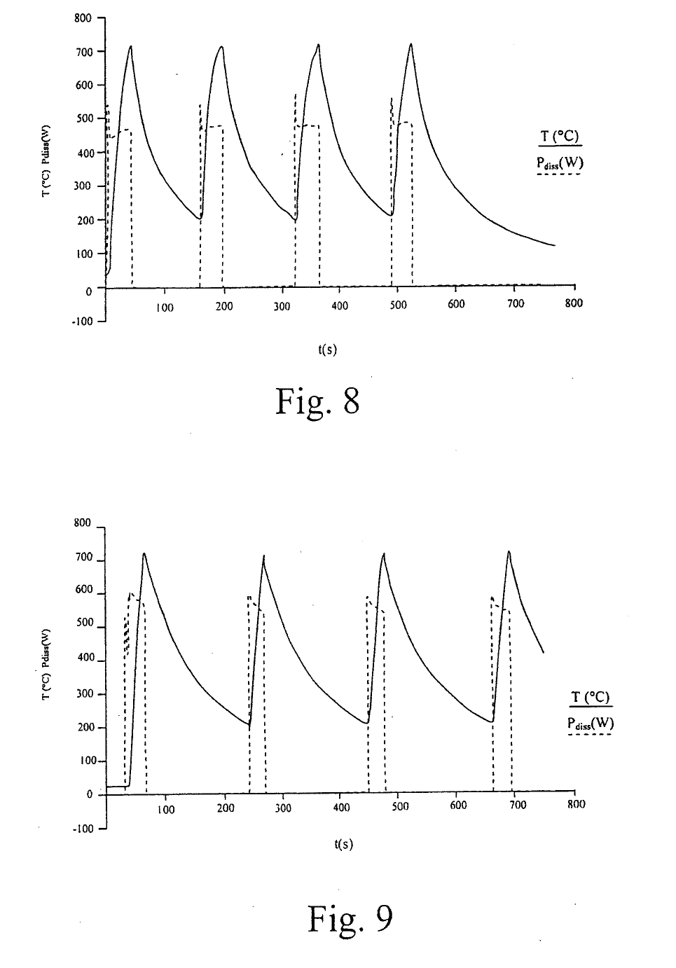

Specimen B had a mass of about 2.99 g. The graph of FIG. 8 represents the temperature curves and the curve of power absorbed by the system during the four cycles of radiation and deactivation of the instrument of FIG. 3. The values detected for the temperature and the power absorbed by the system at each cycle are shown in Table 4 below.

TABLE 4
(specimen B)

| Cycle | Q (J) | ΔT (° C.) |
|---|---|---|
| 1 | 18916,55 | 670 |
| 2 | 18007,06 | 511 |
| 3 | 20057,11 | 518 |
| 4 | 16926,37 | 517 |

### Specimen C:

Specimen C had a mass of about 6.90 g. The graph in FIG. 9 represents the temperature curves and the curve of power absorbed by the system during the four cycles of radiation and deactivation of the instrument of FIG. 3. The values obtained for the temperature and the power absorbed by the system at each cycle are shown in Table 5 below.

TABLE 5
(specimen C)

| cycle | Q (J) | ΔT (° C.) |
|---|---|---|
| 1 | 19580,07 | 686 |
| 2 | 15124,23 | 493 |
| 3 | 16087,52 | 505 |
| 4 | 17056,87 | 509 |

From the analysis of the values emerged for the specimens A, B and C the high repeatability can be seen of consecutive heating and cooling tests in the case of all three specimens. The power value Q actually absorbed by the system has been approximately calculated, i.e. by evaluating the area underlying the curve of power actually absorbed by the system. This can lead to errors, since it includes energy dissipations, which vary according to the mass/volume ratio of the specimen, but at least resulting as significant for the comparison of the results obtained. It is believed that the apparent better behavior of the specimen C (more temperature variation for the same absorbed energy) is likely due to the greater mass of the specimen itself, i.e. a specimen having a lesser surface that dissipates heat.

### Example 9

### Preparation of Specimen Using Clay Mixtures

Susceptor compound mixtures were prepared according to the invention and of a clay material (ceramic clays, feldspar, kaolin and sand) normally used in the ceramic industry for the production of tiles and/or dishware. The amounts of iron silicate (in the form of slag treated as described above) were 50 wt % and 40 wt % respectively. The susceptor compound had a size between 0.1-200 microns. The preparation of the mixture was made utilizing the process of atomization commonly used in the ceramic industry. The resulting atomized substance (having a moisture content of 6%) was pressed into a mold with dimensions 10×5×0.6 cm at a pressure of 300 kg/cm². The specimens thus obtained were then let to dry in a stove for 1 hour at 110° C. and then cooked in an electric roller furnace at a temperature of 1150° C. for 70 minutes. Mechanical breaking load tests executed on the specimens gave values equal to 505 kg/cm².

Heating tests on the specimens were then carried out in a microwave oven for domestic use (2.45 GHz) with a power of 800 W. The average weight of the specimens was approximately 84 g. Temperatures were detected using a portable optical pyrometer with the following results: after 30 sec of heating the surface temperature was equal to 350° C.; 1 minute after, the surface temperature was equal to 650° C. These results were obtained for both compositions 50-50% and 40-60%.

### Example 10

### Preparation of Tiles Utilizing Clay Mixtures

Mixtures prepared according to Example 9 were pressed into an industrial mold of a tile having dimensions 30×30×1 cm at a pressure of 300 kg/cm². The manufactured articles thus obtained were then let to dry in a stove for 1 hour at 110° C. and then baked in an industrial roller furnace, powered by gas, at a temperature of 1050° C. for 90 minutes. From tiles thus made specimens were obtained at the size of 10×10 cm and at an average weight of approximately 280 g.

Heating tests on the specimens were then carried out in a microwave oven for domestic use (2.45 GHz) with a power of approximately 800 W. Temperatures were measured by a portable optical pyrometer with the following results: after 30 seconds of heating the surface temperature was 200° C.; 1 minute after, the surface temperature was equal to 350° C. Also in this case, the same results were obtained for both compositions 50-50% and 40-60%.

### Example 10

### Detection of the Release of Metals from Iron Silicate Specimens into Food

Sintering plates were prepared like Specimen A of Example 7, but using 5 wt of an aqueous solution of polyvinyl alcohol (PVA) at 4% as initial binder. The plates were used for cooking cheese and tomato samples, at a temperature of 100° C. for a period of 30 minutes (repeated contact). The metal content in food after treatment was determined with a Perkin-Elmer OPTIMA 4300 with the detection limit of 0.05 ppm (mg/kg) and evaluated compared with the same food that was not in contact to detect the absence of release. The release of the following metals was searched for: Cd, Cr, Fe, Ni, Pb; for all of these the determined value was below the limit of 0.05 ppm, for both tested foods.

The present invention includes a process for obtaining a composite manufactured article able to increase its temperature when exposed to radiation caused by an electromagnetic field or by electromagnetic waves. The process includes in particular the steps of:
(a) making available at least one inorganic compound susceptible to electromagnetic radiation; and
(b) producing with the mixture and/or with the inorganic compound as such, a composite manufactured article of desired shape and size.

In the case of using a clay-based binder, the amount of susceptor compound according to the invention (iron silicate) in the composition is between 30 wt % and 85 wt %, preferably between 40 and 60 wt % of the final product. During step (b) of the process, a heating of the inorganic compound as it is, or of the mixture conformed with a binder is performed, to obtain the final manufactured article with the desired shape and characteristics. In addition to heating in conventional ovens, heating the mixture or the compound as such can be achieved by subjecting the mixture to microwave radiation.

In one embodiment, the manufactured article contains essentially only iron silicate, sintered to form for example a heating element for boilers or heat exchangers. According to a further embodiment of the invention, the manufactured article is in the form of ceramic, porcelain tile or glazed stoneware, such as a cooking plate for industrial or household use, or as a tile or heating slab for use in industrial processes.

A material of any nature can be heated by placing it in direct or indirect contact, or otherwise in heat exchange connection, with a manufactured article according to the invention when it is subjected to radiation by an electromagnetic field or electromagnetic waves. The fact that the compositions according to the invention are substantially anhydrous, renders particularly surprising the fact that they may be able to absorb the radiation from an electromagnetic field or electromagnetic waves.

The invention provides several advantages over the prior art. First, the iron silicate is a very stable compound, which maintains the +2 oxidation state of Fe even when exposed to air and heated: this represents a major advantage compared to FeO, of which is known the use as a susceptor compound, which is oxidized to Fe +3 when exposed to air. Since the susceptor compounds containing Fe +3 are less performant than those based on Fe +2, FeO must be isolated from air. Simultaneously, the iron silicate is a susceptor compound capable of being heated at very high temperatures, with performances superior to those of silicon carbide (SiC).

A further advantage is the thermal stability of iron silicate, a compound that is amorphous, glass—ceramic, which begins to soften above 1000° C. reaching a melting point at 1500° C. These properties allow its use in iron silicate manufactured articles (i.e. 100% of the refining slag, as mentioned above) substantially free from binders, such as heating elements in boilers and water heaters, where they can reach very high temperatures without negative response. These elements can then replace the known resistors.

A further advantage is the fact that iron silicate, both as it is (i.e. as obtained from refining slag) and as well as cooking elements and similar susceptor materials according to the present invention are suitable for food contact. In particular, they are able to carry out the requested cooking and browning or crisping of food without releasing metals into the food itself, as set forth below.

The compositions subjected to radiation from a electromagnetic field or electromagnetic waves are heated regardless of their moisture content and allow the heating of the materials with which they are placed in a heat exchanging relationship, such as air, water, aqueous solutions, emulsions, oily substances, solvents, viscous resins or the like, or even solids, regardless of moisture content and/or crystallization water of these materials.

Compositions according to the present invention can be used pure or mixed together in order to reach the desired thermal behavior.

Compositions according to the invention may be used in various ways, such as heating the thermoplastic materials otherwise heated only by traditional methods.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense. It is also to be understood that the following claims are intended to cover all of the generic and specific features of the invention herein described, and all statements of the scope of the invention which, as a matter of language, might be said to fall therebetween.

What is claimed is:

1. A susceptor material comprising iron silicate to increase the temperature of the susceptor material when exposed to radiation caused by an electromagnetic field or electromagnetic waves.

2. The susceptor material according to claim 1 wherein the susceptor material is a composition further comprising at least one organic or inorganic binder, the iron silicate being in the form of particles dispersed in the binder, the composition being suitable to be formed in a desired shape and size to provide a manufactured article.

3. The susceptor material according to claim 2, wherein the binder is selected from the group consisting of ceramic clay, feldspar, mixtures thereof and similar materials suitable for the production of ceramics, porcelain, tiles, stoneware and similar products.

4. The susceptor material according to claim 2 wherein the iron silicate is in a quantity within the range of between 30 wt % and 85 wt % of the composition.

5. The susceptor material according to claim 2, wherein the binder contains a quantity of water less than 2.0% (w/w).

6. The susceptor material according to claim 2, wherein the binder is a clay-based binder and the composition is combined with another material to make a product, the iron silicate being in a quantity within the range of between 40 wt % and 60 wt % of the final product.

7. The susceptor material according to claim 1, wherein the iron silicate is a synthetic granulated slag resulting from the refining of ferrous and non ferrous metals.

8. The susceptor material according to claim 2, wherein the iron silicate is a synthetic granulated slag resulting from the refining of ferrous and non ferrous metals.

9. The susceptor material according to claim 7, wherein the granulated slag is a byproduct of copper metallurgy

10. The susceptor material according to claim 8, wherein the granulated slag is a byproduct of copper metallurgy

11. A method of manufacturing process for obtaining a composite manufactured article that increases in temperature when exposed to radiation caused by an electromagnetic field or electromagnetic waves, comprising the steps of:
(a) providing an inorganic susceptor material, sensitive to electromagnetic radiation, said inorganic compound comprising iron silicate; and
(b) subjecting the inorganic susceptor material to heat and imparting any desired shape to yield an article of manufacture.

12. The method according to claim 11 wherein the iron silicate is in a quantity within the range of between 30 wt % and 85 wt % of the inorganic susceptor material.

13. The method according to claim 11 wherein the inorganic susceptor material is a compound further comprises at least one organic or inorganic binder.

14. The method according to claim 12, wherein said binder is combustible and the susceptor material is shaped and sintered at a sufficient temperature to cause the combustion of said binder and the formation of a manufactured article containing at least 90 wt % of iron silicate.

15. The method according to claim 11 wherein the iron silicate is a synthetic granulated slag that is a byproduct of copper metallurgy

16. An article of manufacture comprising a susceptor material able to increase its temperature when exposed to radiation caused by an electromagnetic field or electromagnetic waves, wherein said susceptor material comprises at least in part the iron silicate.

17. The article of manufacture according to claim 14, wherein quantity of iron silicate is within the range of between 30 wt % and 85 wt % of the susceptor material.

18. The article of manufacture according to claim 16, wherein the susceptor material the susceptor material is a composition further comprising at least one organic or inorganic binder, the iron silicate being in the form of particles dispersed in the binder.

19. The article of manufacture according to claim 18, wherein the binder is a clay-based binder and the iron silicate is in a quantity within the range of between 40 and 60 wt % of the article of manufacture.

20. The article of manufacture according to claim 16, wherein the article of manufacture is selected from a group consisting of a heat exchanger or the coating of a heat exchanger; a heating container for food; a hot plate for cooking food and/or for heating a cooking element; a cooking element for surface cooking of food; warming plates, panels or internal coating of domestic and/or industrial ovens, a heating element selected from a cylindrical shaped element, a heating element of a boiler for the production of hot water in a heating system and/or sanitary hot water, a heating element of a fan coil unit for the heating of air.

21. The article of manufacture according to claim 16 wherein the article of manufacture comprises a thermoplastic material combined with the susceptor material.

21. The article of manufacture according to claim 16, wherein the article of manufacture is a heating element comprising at least 90% (w/w) of iron silicate.

22. The article of manufacture according to claim 16, wherein the article of manufacture is selected from a group consisting of a plate, a slab or a pot or pan for food for cooking or heating food.
